(19) United States
(12) Patent Application Publication
(10) Pub. No.: US 2010/0076397 A1
(43) Pub. Date: Mar. 25, 2010

(54) DUAL-LUMEN NEEDLE WITH AN ELONGATE NOTCH OPENING

(76) Inventors: Jay Reed, Elk Grove Village, IL (US); Kevin Helle, Bartlett, IL (US)

Correspondence Address: GE HEALTHCARE, INC., IP DEPARTMENT 101 CARNEGIE CENTER, PRINCETON, NJ, 08540-6231, US

(21) Appl. No.: 12/515,561

(22) PCT Filed: Nov. 30, 2007
(86) PCT No.: PCT/US2007/086017

§ 371 Date: May 20, 2009

Related U.S. Application Data
(60) Provisional application No. 60/867,929, filed on Nov. 30, 2006.

(51) Int. Cl. A61J 1/20

(52) U.S. Cl. 604/411

(57) ABSTRACT

A dual-lumen needle for aseptic filling and withdrawal of fluids from septum-plugged containers.

### FIELD OF THE INVENTION

The present invention is directed to the field of radiopharmaceutical handling equipment. More specifically, the present invention relates to a dual-lumen needle which allows the sterile transfer of pharmaceutical fluids.

### BACKGROUND OF THE INVENTION

A basic premise for the manufacture and handling of pharmaceutical fluids is the use of aseptic techniques. The pharmaceutical fluids are typically held within a container having a pierceable septum. The containers typically include a pharmaceutical type I glass bottle, a polymeric re-sealing septum, and an aluminum seal crimped onto the neck of the bottle and over the septum. These containers, depending on their function in the delivery chain of the pharmaceutical, are either meant to be filled with the pharmaceutical fluids or to supply the pharmaceutical fluid to another container or syringe or the like. Typically the components are cleaned and sterilized, then aseptically assembled, whereby the fluid is added to the bottle, the septa is inserted on the bottle, then the septa is capped and sealed with an aluminum seal. Alternatively, the components may be cleaned and sterilized, aseptically assembled with the drug product, and then the entire finished unit is terminally sterilized.

Whether the particular operation requires the pharmaceutical to be withdrawn from or added to the container, the art employs two needles for piercing the septum of the container. One needle is used for conducting the pharmaceutical into or out of the container. The other needle is used to either vent the container, ie, to allow the gas within the container to escape during filling, or to allow gas into the container to replace the void volumes created as the fluid is withdrawn and to prevent overpressure of the filled container. For example, sterile saline is often removed from one container to reconstitute freeze-dried pharmaceutical product in another container. Another example is the removal of Technetium-99m from one pharmaceutical container to reconstitute freeze-dried pharmaceutical product in another container. It is highly desirable that these pharmacy operations be performed aseptically.

Placement of two needles through the septum is difficult and fraught with risks to the pharmaceutical product and to the people handling it. One of the needles may be improperly positioned such that it hits the aluminum crimp, damaging both the crimp and/or the needle and causing a unit failure. If the open ends of the two needles are positioned in too close proximity to each other, liquid could transfer from one needle to the other and, especially when transferring a radiopharmaceutical fluid, cause a radioactive contamination event outside of the container and on or near personnel.

Additionally, should the septum core into the vent needle, thereby blocking it, can cause undetected overpressure in the filled container as the vent needle does not allow gas in the container to escape during filling. The overpressure may cause the contents to spray out onto the pharmacist when drawing patient doses from the container. Such problems also complicate the automation of such processes whereby additional handling equipment is required to precisely insert both needles through a septum.

The art has seen devices which could puncture a septum and provide both a fill path and a venting path, however, each of these devices cannot provide for aseptic fluid transfer whereby the septum integrity is retained after the fluid transfer operation.

For example, U.S. Pat. No. 7,091,494, which is commonly owned by the assignee of the instant invention, describes a dual-lumen spike for puncturing the septum of a container holding a radiopharmaceutical. The spike provides a first lumen for conducting fluid from the septum and a second lumen for venting the container. However, the large bore of a spike does not maintain the integrity of the septum after it has been withdrawn therefrom. The radiopharmaceutical remaining in the container would therefore be exposed to the outer environment.

Millipore Corporation manufactures and sells a dual needle concept under the tradename Sterisolutest. This product is used to remove finished pharmaceutical product from vials for sterility testing. Millipore has added a plastic fluid path for liquid transfer over the large bore needle, resulting in a very large bore requiring greater pressure and significant deformation of the septum in order to accomplish the fluid transfer. While it may be used in an aseptic operation, this device destroys the septum integrity such that the container would lose its hermetic seal at the conclusion of the process, thereby exposing the contents of the container to the outer environment.

Baxa manufactures a needle which provides venting by including plastic hub having radially-projecting fins extending annularly about the needle. Venting is accomplished by pushing the needle hub all the way into the septum such that the hub wings penetrate and further spread open the septum, allowing gas to travel through the grooves between the wings in the plastic hub. However, this design destroys the re-sealing of thin septums while thick septums are able to fill in around the wings and thereby prevent venting. Moreover, this is neither an aseptic operation, nor does it allow for verification of bacterial retention testing.

Wallace manufactures an oocyte recovery system using a dual lumen needle. One lumen is used to deliver a solution for internal lavage of the uterus. The other lumen is used to aspirate the solution in the recovery of oocytes. The needle is either 16 or 17 gauge and is 30-33 centimeters long. It includes 1 centimeter of echomarking at its free end. The length and construction of this needle preclude its use in aseptic filling operations, especially when conducting radiopharmaceuticals as there would be too much radioactive product retained within the needle itself.

The art would therefore benefit from a single needle which could both conduct fluid and vent the container in a manner that maintains the integrity of the septum of the container. The single needle would allow for aseptic filling and withdrawal of fluid into or out of the container. Such a needle would allow for the aseptic and terminal sterilization manufacture of pharmaceutical drug products into pre-sterilized, pre-sealed bottles. If purchased from a supplier, such a needle would eliminate the need for significant facility infrastructure, maintenance and monitoring, and validation of major systems in pharmaceutical plants, such as clean steam, water for injection, water for injection distribution systems, oil free compressed air, and facility clean-room HVAC.

### SUMMARY OF THE INVENTION

In view of the needs of the prior art, the present invention provides a dual-lumen needle which is capable of being inserted through the septum of a container plug to provide fluid transfer either into or out of the container while maintaining septum integrity after the fluid transfer operation and the needle is withdrawn from the septum.

Additionally, the present invention allows for a filter media to be placed in line with a vent passageway of the dual-lumen needle. By providing the filter separately, the present invention allows for unique testing for bubble-point or pore size verification so as to establish an asceptic fill when using the dual-lumen needle.

### BRIEF DESCRIPTION OF THE DRAWINGS

FIG. 1 depicts a cross-sectional view of a dual-lumen needle of the present invention inserted into a container having an elastomeric septum.

FIG. 2 depicts a cross-sectional view of the hub a dual-lumen needle of the present invention showing the orientation of the two lumens therein.

FIG. 3 depicts the notch of the first lumen into which seats the second lumen in accordance with the present invention.

FIG. 4 depicts an oblique view of the seating of the second lumen in the notch of the first lumen.

FIG. 5 depicts a side view of the two lumens used in the present invention.

FIG. 6 depicts a top elevational view of how the second lumen seats in the notch of the first lumen.

FIG. 7 depicts a cross-section view of the interior of the hub of a dual-lumen needle.

FIG. 8 depicts an alternative interface of the lumens of a dual-lumen needle of the present invention, where the second lumen has an elongate vent port.

FIG. 9 depicts the interface of the second lumen in the notch of the first lumen, where the second lumen includes a transverse end-wall.

### DETAILED DESCRIPTION OF THE PREFERRED EMBODIMENT

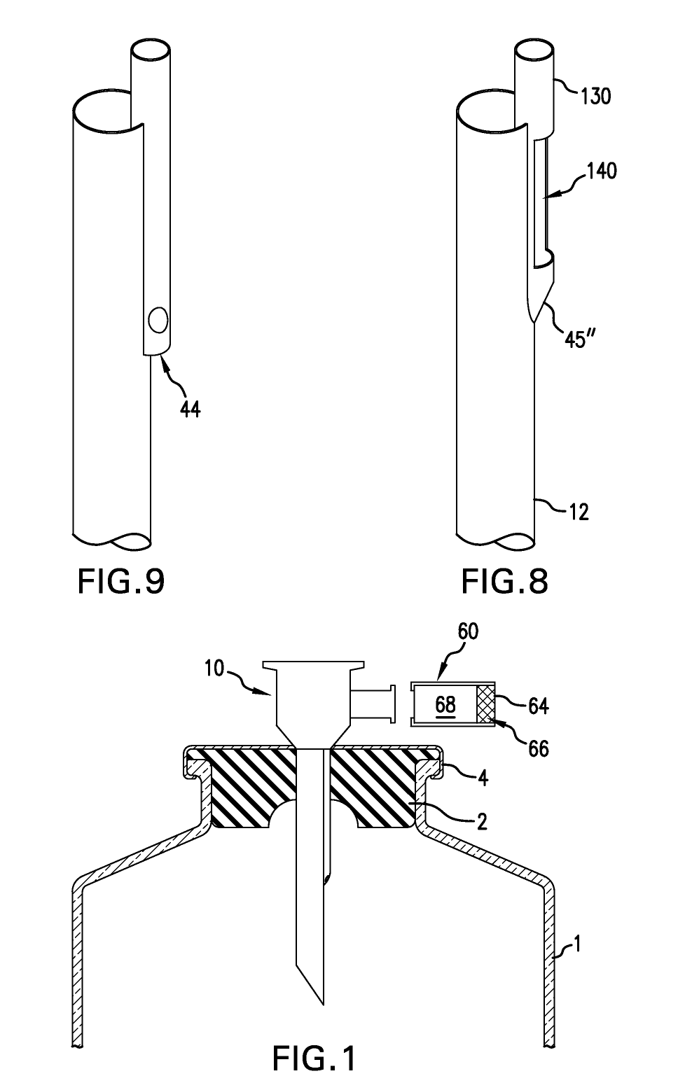

With reference to FIG. 1, the present invention provides a dual-lumen needle 10. Employing a tube-in-a-tube-wall design, needle 10 allows the transfer of fluid into a container 1 having penetrable self-resealing septum 2 and a foil seal 4 using only a single needle penetration. Additionally, a small-bore single penetration will still leave a hermetically sealed container following a filling or withdrawal process. The present invention provides a single needle puncture during trans-septal fluid transfer. The needle is desirably fitted with a modified luer lock hub to allow for easy connection and separation of the fluid and gas paths.

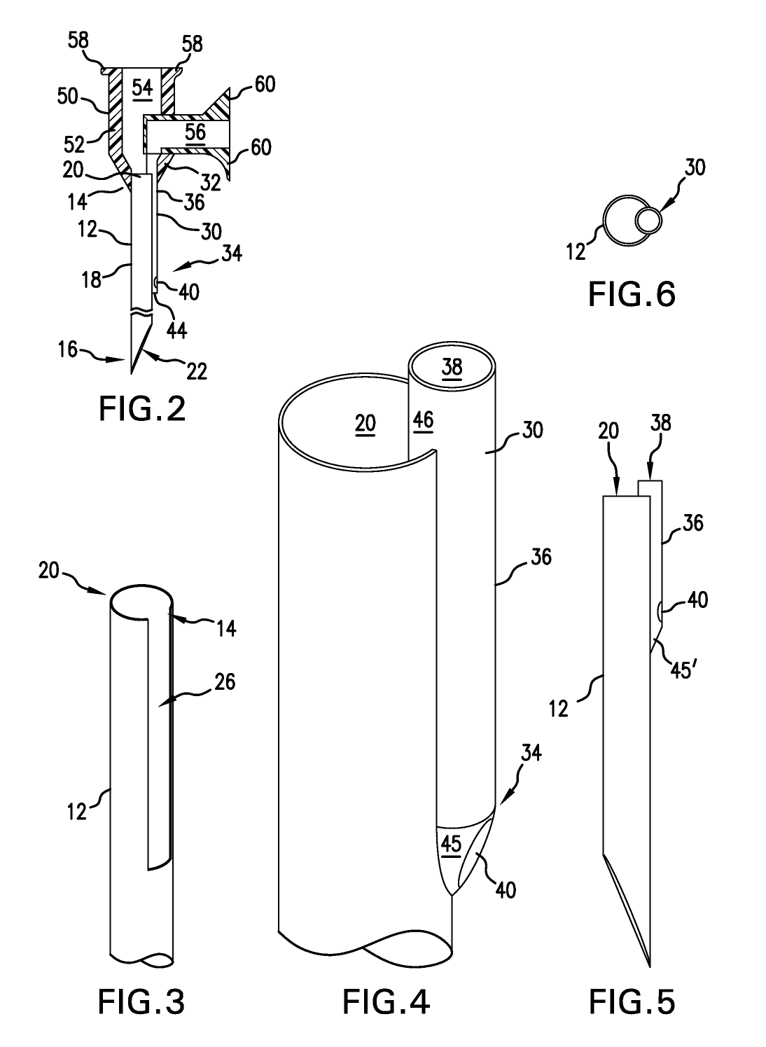

With reference to FIGS. 2-7, needle 10 includes a first lumen 12 having opposed first and second open ends 14 and 16, respectively, and an elongate first tubular body 18 extending therebetween. First open end 14 defines a hub port 20, second open end 16 defines a flow port 22, and tubular body 18 defines an elongate passageway 24 extending in fluid communication therebetween. Tubular body 18 further defines an elongate notch 26 opening on first end 14. Notch 26 accommodates a second lumen 30 having opposed first and second open ends 32 and 34, respectively, and an elongate second tubular body 36 extending therebetween. First open end 32 defines a gas port 38, second open end 34 defines a vent port 40, and tubular body 36 defines an elongate vent passageway 42 extending in fluid communication therebetween.

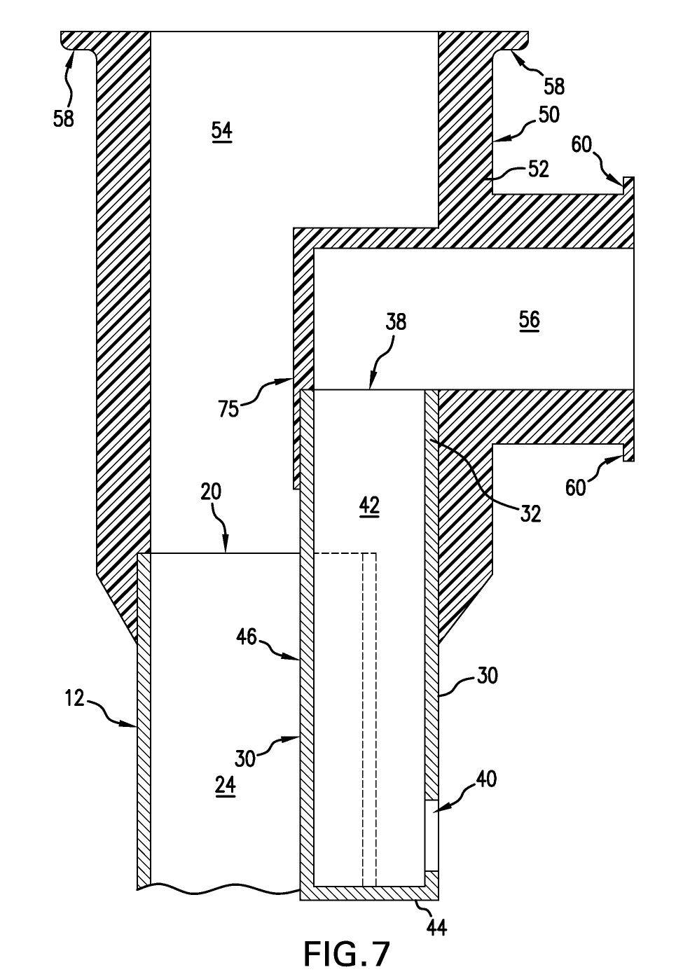

As shown in FIGS. 2 and 7, second open end 34 may include a transverse endwall 44 so as to maintain fluid isolation between passageway 24 and vent passageway 42 along second lumen 28. Endwall 44 may be formed from a biocompatible adhesive or solder which applied to lumen 28, or by using a closed-end lumen to form lumen 28 and forming vent port along the sidewall thereof. The interface between lumens 12 and 30 at notch 26 is desirably sealed so as to be fluid-tight. The interface may be sealed by a biocompatible adhesive, solder, or any means known to those of skill in the art. Any other means of so isolating passageways 24 and 42 as known to those of skill in the art are also contemplated. As seen in FIGS. 4, 5, and 8, the present invention contemplates that second open end 34 of second lumen 30 includes a tapered endwall 45, 45′, and 45″, respectively.

Lumen 30 includes a cylindrical outer surface 46 a portion of which extends into first passageway 24 of lumen 12. Needle 10 includes a hub 50 having a hub body 52. Hub body 52 defines first and second open hub passageways 54 and 56 extending in fluid communication with passageway 24 and vent passageway 42, respectively. FIG. 7 shows more detail on how first and second lumens 12 and 30 are seated in hub body 50 so as to provide separate passageways for a fluid to be delivered through passageway 24 and a gas to be conducted through passageway 42. Hub body 50 includes a projecting wall 75 which annularly engages first end 32 of second lumen 30 so as to place gas port 38 in fluid communication with hub passageway 56. Hub body desirably provides first and second pairs of luer hubs 58 and 60, respectively, for providing easy connection to other fluid conduits.

As shown in FIG. 1, it is contemplated by the present invention that the second pair of hubs 60 provide connection to an elongate hollow vent conduit 62 supporting a filtration media 64 therein. Filtration media defines a filtered gas passageway 66 therethrough in fluid communication with conduit passageway 68. By providing filtration media 64 in a separately-attachable conduit for needle 10, an operator may separately inspect the quality and performance of the filtration media prior to attaching to hub 50 and using needle 10 in dispense or withdrawal operations.

Second end 16 of first lumen 12 includes a beveled tip 60 which further defines flow port 22. Tip 60 may be conventionally or otherwise shaped to provide for ease of septum penetration in a manner that will allow the septum to sealingly engage tubular body 18 during fluid transfer and to then re-seal upon withdrawal of needle 10 and thereby maintain the sterility of the contents of the container which the septum seals. One penetration in a single manipulation maximizes the likelihood of success for aseptic transfers. Alternatively, the needle tip may be blunt-shaped or provide a transversely-opening flow port. The particular tip design may be selected so as to maximize the number of penetrations achievable by needle 10 prior to requiring replacement. Vent port 40 is desirably provided to be longitudinally-spaced from flow port 22 so as to allow avoid the necessity of mixing between the gas flowing passageway 24 and fluid flowing through passageway 42.

FIG. 5 depicts an alternate embodiment of dual-lumen needle 10, whereby the second ends 14 and 34 of the two lumens are symmetrically beveled about the longitudinal axis of needle 10. It is contemplated that the second ends 14 and 34 are generally oppositely beveled (as shown in FIG. 5) about the longitudinal axis of needle 10. Alternatively, it is further contemplated that second ends 14 and 34 may be beveled in a generally similar direction. It is desirable that the bevels of each lumen be oriented so as to minimize the stresses on a septum as second end 34 of lumen 30 is inserted therethrough, as a single penetration per manipulation maximizes the likelihood of success for aseptic transfers.

During operation needle 10 typically provides a liquid through first lumen 12 as it extends further into a container than second lumen 30. It is desirable during either the delivery or removal of a liquid that there is no instance where the gas flow path is submerged in the liquid being delivered or removed. This assumes most operations will bring needle 10 in a downward direction into a container. However, in instances where needle 10 is directed in an upwards direction through a pierceable septum into a container, it may be desirable to deliver or remove fluid though the now-lower open end of second lumen 30. It is contemplated that one or ordinary skill of the art will recognize that in such applications it may be desirable to provide a gas filtration media to span across the vent port of the needle.

Needle 10 further allows an operator to pull a vacuum and back-fill a head space gas, such as N₂ without requiring a second puncture of the septum.

Lumen 12 is desirably made from standard 316L stainless steel and may be nickel plated or plated with other metals based upon drug compatibility. Lumen 12 may be 16 gauge or smaller and desirably 17 gauge or smaller. Lumen 30 may be of identical materials as the primary lumen. Alternatively, lumen 30 may be constructed of a pharmaceutically- or chemically-inert plastic polymer, the selection of which may be dictated by the particular pharmaceutical or chemical being transferred. If lumen 30 is manufactured from a plastic polymer, it is possible to manufacture or mold the inner lumen and the hub concurrently. It is contemplated that the secondary tube has a cross-sectional area that is approximately 33% to 50% of the cross-sectional area of the primary lumen. Second lumen 30 is a smaller diameter tube than first lumen 12 and does not extend beyond the second end 16 of lumen 12 and provides for gas transfer.

Hub 50 is desirably formed as a unitary construction. Alternatively, it is contemplated that it may be formed from two or more component parts to form the hub body as contemplated by the present invention. Hub 50 may be constructed of similar materials as currently utilized by needle manufacturers. The hub material should not leach into the pharmaceutical formulation or shed particulate. Making the retentive filter media 64 separately attachable to hub 50 allows for off-line integrity test verification of filter pore size prior to using the needle of the present invention. Lumen 12 may be attached to the hub in a similar manner as needles are presently attached. It is desirable to increase the distance between the primary needle connection point and the luer fitting in order to accommodate the exit of the second lumen.

As it is possible for fluid to enter second lumen 30 during fluid transfer through first lumen 12, it is desirable to increase the diameter of gas flow path either at lumen 30, hub passageway 56, or at some section along its length prior to filtration media 64. Alternatively, the filter may be incorporated into the second end of the secondary lumen nearer the vent aperture so as to prevent liquid flow too far into passageway 42.

A hydrophobic filter is desirably utilized on a gas venting tube attachable to hub 50 so as to be in fluid communication with passageway 42 of second lumen 30. The filter is formed such that gasses can pass therethrough, but are not wetted by aqueous solutions. Alternatively, the hydrophobic filter may be molded into the needle hub and act as a sterile gas vent. Alternatively, the hydrophobic filter may be attached to the terminal end of the gas vent tube. Non-aqueous solutions such as oils and alcohols may, conversely, utilize a similar design but with a hydrophilic filter as a vent. The filter desirably has a pore size that is bacterial retentive, such as 0.22 micron or 0.45 micron. Desirably, a common fitting such as a luer lock terminates the flexible tubing to allow for the attachment of a filter, either hydrophobic or hydrophilic as required.

FIG. 8 is a partial view of the two lumens an alternate dual lumen needle 110 of the present invention. This embodiment includes first lumen 12 as described hereinabove. The second lumen 130 defines an elongate vent port 140. The vent port of the present invention is contemplated to be of any shape and size suitable for allowing gas to pass therethrough.

It is further contemplated that second lumen 30 alternatively defines a vent aperture at open end 34 which opens in direct fluid communication with both passageway 24 of first lumen 12 and the outside of needle 10.

Additionally, as it is possible for fluid to enter the secondary lumen during fluid transfer through the primary lumen, it is desirable to increase the diameter of the gas lumen at some point along its length. Alternatively, the filter may be incorporated into the second end of the secondary lumen or separately attached, as shown in FIG. 1, to a needle of the present invention. When the filter is separately attached to the needle, the filter attachment may provide a gas flowpath of increased diameter as compared the second lumen.

While the particular embodiment of the present invention has been shown and described, it will be obvious to those skilled in the art that changes and modifications may be made without departing from the teachings of the invention. The matter set forth in the foregoing description and accompanying drawings is offered by way of illustration only and not as a limitation. The actual scope of the invention is intended to be defined in the following claims when viewed in their proper perspective based on the prior art.

What is claimed is:

1. A dual-lumen needle for delivering fluid comprising
a first elongate tubular body having opposed first and second open ends and defining an elongate first passageway extending therebetween, said tubular body further defining an elongate notch opening on said first open end;
a second elongate tubular body comprising opposed first and second open ends and defining a second elongate passageway extending therebetween, at least a portion of said second tubular body is seated within said notch of said first tubular body; and
a hub body supporting said first and second elongate tubular bodies, wherein said hub body defines a first hub passageway in direct fluid communication with said first passageway of said first tubular body and a second hub passageway in direct fluid communication with said second passageway of said second tubular body.

2. A dual-lumen needle of claim 1, further comprising filtration means defining a filtration passageway threrethrough, said filtration passageway being in fluid communication with said second passageway of said second tubular body.

3. A dual-lumen needle comprising:
a first elongate lumen comprising opposed first and second ends and an elongate first tubular body extending therebetween, said first tubular body defining an elongate passageway in fluid communication with said first and second open ends of said first lumen, said first tubular body further defining a first elongate notch opening onto said first open end;
a second elongate lumen comprising opposed first and second ends and an elongate second tubular body extending therebetween, said second tubular body defining an elongate passageway in fluid communication with said first and second open ends of said second lumen, wherein at least a portion of said second lumen is located within said notch of said first lumen;
a hub comprising a hub body defining a first open hub passageway extending therethrough in fluid communication with said first passageway of said first lumen and a second open hub passageway extending therethrough in fluid communication with said second passageway of said second lumen; and

4. A dual-lumen needle of claim 3, further comprising a filtration media defining a gas passageway therethrough, said gas passageway in fluid communication with said second passageway of said second lumen.

5. A dual-lumen needle of claim 4, wherein said filtration media extends across said second passageway of said second lumen.

6. A dual-lumen needle of claim 4, wherein said filtration media filters fluid flowing through said second hub passageway.

7. A dual-lumen needle of claim 4, wherein said filtration media extends across a tubular passageway in fluid communication with said second hub passageway.

8. A dual-lumen needle of claim 7, wherein said tubular passageway is defined by a tube removably attached to said hub.

9. A dual-lumen needle of claim 3, wherein said vent port is longitudinally-spaced from said second open end of said first lumen.

10. A dual-lumen needle of claim 3, wherein said first tubular body of said first lumen defines its corresponding second open end to open transversely to the longitudinal axis of said first lumen.

11. A dual-lumen needle of claim 1, wherein said first tubular body of said first lumen has a cross-sectional dimension of a 16 gauge needle.

12. A dual-lumen needle of claim 3, wherein said first tubular body of said first lumen has a cross-sectional dimension less than a 16 gauge needle.

13. A dual-lumen needle of claim 3, wherein said second opening of said first tubular body opens in a direction substantially transverse to the longitudinal axis of said first tubular body.

14. A dual-lumen needle of claim 3, wherein said second opening of said first tubular body is axially-aligned with the longitudinal axis of said first tubular body.

15. A dual-lumen needle of claim 3, wherein said hub supports at least one pair of luer fittings thereon.

16. A dual-lumen needle of claim 1, wherein said vent port opens transversely to the longitudinal axis of said second tubular body.

17. A dual-lumen needle of claim 1, wherein said vent port is longitudinally-spaced from said flow port.

18. A dual-lumen needle of claim 1 having a cross-sectional dimension of a 16 gauge needle.

19. A dual-lumen needle of claim 1 having a cross-sectional dimension less than a 16 gauge needle.
